(19) United States
(12) Patent Application Publication
(10) Pub. No.: US 2006/0161375 A1
(43) Pub. Date: Jul. 20, 2006

(54) Optimizing processing speed based on measured temperatures

(76) Inventors: Allen Duberstein, Portland, OR (US); Stephen H. Gunther, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,838

(22) Filed: Dec. 30, 2004

(51) Int. Cl. G01K 1/08; G06F 15/00

(52) U.S. Cl. 702/132

(57) ABSTRACT

A processor or other controller may operate at different speeds depending upon a sensed temperature. In one embodiment the invention includes detecting an operating temperature of a first processor core and a second processor core, comparing the detected temperatures to a first threshold, increasing the speed of the first and the second processor core from a first speed to a second higher speed if the detected temperature of at least one of the first and second processor core is below the first threshold, and decreasing the speed of the first and the second processor core from the second speed to the first speed if the detected temperature of at least one of the first and the second processor core is above the first threshold.

### BACKGROUND

1. Field

The present description relates to thermal management for semiconductor devices, and in particular, to increasing the speed of a device based on thermal conditions.

2. Related Art

Semiconductor devices generate heat internally that, if left uncontrolled, can destroy the device. The heat generated by a device is related to its operating speed, its operating voltage and its level of activity. To dissipate extra heat, a device may be equipped with a large cooling surface, heat fins, fans or a more complex liquid cooling system. The cooling system allows the device to operate at some level of activity without overheating.

Semiconductor devices are normally designed to operate at a fixed speed and voltage based on a prediction of normal activity levels and cooling systems. As a result, when the device has less activity or is provided with better cooling, the device runs slower than necessary. Even at expected activity and cooling levels, many devices run slower than necessary in order to accommodate a sudden increase in activity.

Multiple core processors may be even more likely to run slower than necessary. With multiple cores, an application may use primarily one part of a processor core, or operate on only one of the available cores. The other, less utilized core may be running much more slowly than necessary to prevent overheating.

### BRIEF DESCRIPTION OF THE DRAWINGS

Embodiments of the present invention will be understood more fully from the detailed description given below and from the accompanying drawings of various embodiments of the invention. The drawings, however, should not be taken to be limiting, but are for explanation and understanding only.

FIG. 1 is a diagram of processor core temperatures and zones corresponding to particular speeds according to an embodiment of the present invention;

FIG. 2 is a state diagram of different processor speed states and transitions between them according to an embodiment of the present invention;

FIG. 3 is a process flow diagram of controlling processor core speed based on a sensed temperature according to an embodiment of the present invention;

FIG. 4 is a block diagram of processor with multiple processor cores and associated temperature and control hardware suitable for an embodiment of the present invention; and

FIG. 5 is a block diagram of computer system with processors suitable for an embodiment of the present invention.

### DETAILED DESCRIPTION

In one embodiment of the invention, conventional power management technology may be altered to include an additional temperature threshold in the thermal monitoring system. The additional threshold, a high speed threshold (HST), may be calibrated to a temperature lower than the TCP (thermal control point), or throttle point. When any of the processor cores operates above this set point, then the processor may operate at boot speed or marked speed. When all of the processor cores are operating below the high speed threshold, then the clock speed and voltage setting may be increased. The clock speed may be increased by one or more bus ratio steps for less demanding server applications as well as for many single core applications. Such a multiple threshold control may be applied to processors with a single core or with multiple cores.

Using a high speed threshold for increasing processor speed allows the processor to offer its maximum performance over a wide variety of application sets. The additional threshold and control logic adds almost no cost or complexity to the processor.

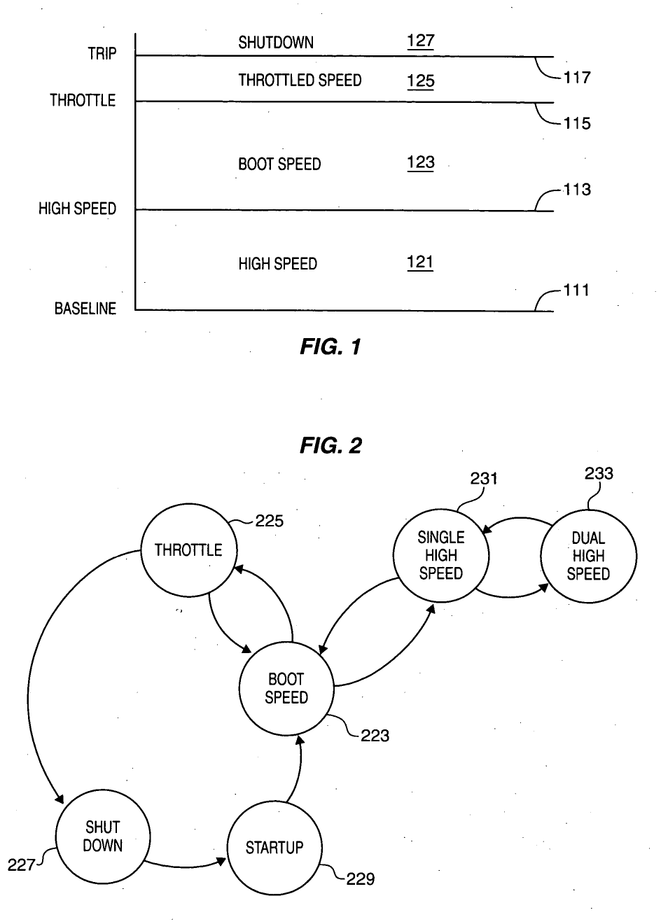

FIG. 1 shows a diagram of thermal zones of operation according to one embodiment of the invention. In FIG. 1, four thermal levels or temperatures are defined. The temperatures for each level increase up the figure. The highest threshold of FIG. 1 is a thermal trip threshold 117. If the temperature of one or more cores of the processor surpass the thermal trip threshold, then the processor may be shut down. The thermal trip threshold may be set at a temperature very close to the maximum temperature that the processor can sustain without serious damage.

The next cooler threshold is a thermal throttle threshold 115. A throttle speed zone 125 lies between the throttle speed threshold 115 and the thermal trip threshold 117. This temperature difference between the two upper thresholds allows for a margin of safety between safe operation of the processor and physical damage from overheating. When one or more cores of the processor reach a temperature within the throttle speed zone, the processor's operation is throttled. Throttling may involve reducing the processor frequency and voltage or may involve restricting the operating duty cycle. This lower speed may be one half, one third, or less of the boot speed. The throttled state is intended to cool the processor quickly yet still allow the system to operate and may be accompanied by a reduced voltage.

The next cooler threshold is a high speed threshold (HST) 113. A standard speed or boot speed zone 123 lies between the high speed threshold 115 and the throttle threshold 117. This zone corresponds to normal processor operation. When the processor core or cores are operating between the high speed temperature threshold and the throttle temperature threshold, the processor will operate at standard or boot speed. This corresponds to normal operation and, under normal circumstances, the processor should maintain a fairly steady operational temperature.

The lowest level is a baseline operating temperature 111 that may be largely dictated by the platform ambient conditions. A high speed operational zone 121, lies below the high speed threshold. If the processor core or cores have a measured temperature below the high speed threshold, then the processor core or cores may be operated at an elevated speed and voltage. This speed and voltage are higher than the boot zone 123 speed. The amount of the increase will depend upon the particular processor and perhaps also the operating environment. The high speed zone allows the processor to provide faster processing for applications with lower processing demands or for operations that do not fully employ both cores. It may also allow the processor to take advantage of a cooler operating environment.

Many different variations may be made to the threshold levels and the operational modes in each of the described zones. The baseline threshold may represent a base operating temperature that is achieved immediately after startup. However, other temperature levels may be selected. The baseline temperature may also be ignored. In some embodiments of the invention, in normal operation, the processor enters the boot speed mode after startup regardless of temperature.

The high speed threshold may be set during device characterization at the factory when data is collected during operation with wide varieties of application work loads. It may also be set by a systems integrator based on a specific application or hardware environment, or by a user for a specific purpose or set of applications. The high speed threshold may be high enough to provide a useful operating area of high speed operation. At the same time, a substantial distance from the throttle speed threshold may reduce jitter.

In one embodiment of the invention, the high speed threshold is set to about 90° C. and the throttle threshold is set to about 100° C. The thermal trip threshold may be set to about 110° C. These values are provided as an example using some current technologies. Higher or lower values may be used as appropriate under the circumstances. The relative difference between the high speed threshold and the throttle threshold may be more or less depending on the desired safety margin, speed, and thermal control system.

The throttle threshold, the thermal trip threshold and the high speed threshold may be determined using conventional methods, such as with reference to the TDP (thermal design power). TDP may be selected to represent the maximum power level that may be continuously maintained on a heavily loaded processor in its expected environment without throttling. TDP may be determined during device characterization and is typically 70% to 90% of the maximum power that the processor can generate instantaneously. While only three thresholds are shown, additional thresholds may also be used.

The boot speed operating mode may use any of a variety of different settings for speed and voltage. In some embodiments, the conventional marked speed and voltage may be used. This speed and voltage is typically marked on the chip package and accompanying paperwork and stored in a register of the processor that can be accessed by the system bus, system interconnect, or other system resources. When the processor starts up, it reads a system bus or system interconnect boot fraction from the register and applies this to the system clock to generate a clock for the processor core. The processor core clock is then some multiplier of the system clock. The boot speed may be determined at the factory during device characterization, or it may be set by a systems integrator or user.

In a multiple processor environment, the boot speed may be the lowest marked speed of all of the processors in the multiple processor group. Some alternative faster or slower speed may also be used. The boot speed may be an operational speed at which the processor should have a stable temperature when operated in a defined environment and equipped with a specified heat sink. For purposes of the present application, the boot speed may be considered as a baseline for the other speeds but the boot speed may be set in a variety of different ways.

The high speed settings may be determined in a manner similar to the boot speed settings. A parameter may be stored in a register of the processor during manufacture or test. Alternatively, the BIOS (Basic Input/Output System), an ICH (Input/Output Controller Hub) or system interconnect may control the settings for high speed operation. The high speed settings may be ten, twenty, thirty or more percent faster than the boot speed. The particular choice for the high speed setting may depend on the anticipated operating environment, and the thermal management system among other factors.

While only one high speed zone is shown in FIG. 1, there may be several high speed thresholds, zones and corresponding settings, one for each zone. Accordingly, when the processing cores are cool, they may be operated at 20% or higher speeds up to a high speed limit that is based on several processor parameters in addition to power. If the cores warm up, the speed may be reduced in several steps to 10 or 5 percent higher speeds until the cores reach the boot speed zone. The core speeds may be adjusted independently or as a group to protect the hottest core from overheating.

The throttled speed may be obtained in a variety of different ways. In one embodiment, a duty cycle is imposed on the system clock that supplies the processor clocking section. This duty cycle removes 1 of 2, 2 of 3, 3 of 4 or some other portion of the processor clock pulses, effectively reducing the processor core clock speed. In another embodiment, the processor clock rate is reduced and the voltage supplied to the processor is also reduced. Any of a variety of other approaches may be used to reduce the heat generated by the processor. There may be single or multiple levels of throttling. Alternatively, or in addition, cooling may be increased.

In some processor designs, it may be possible to control the speed and voltage of different processor cores independently. In other processor designs it may be possible to control core speed independently, while both cores are coupled to the same power plane for voltage. With such a processor, the temperatures of the various cores may be monitored independently and the operating modes of each processor core may be controlled separately. So, for example, if the temperature of core 1 is in the boot speed zone and the temperature of core 2 is in the high speed zone, the two cores may be operated at speeds corresponding to their respective zones instead of both cores being operated in the boot speed zone as described above. If the processor does not permit different core voltages, then if core 1 is operated at high speed and high voltage, then core 2 at boot speed may also be operated at high voltage. If core 1 then enters the boot speed zone, then the voltage for both cores may be reduced while both cores are operated at boot speed.

FIG. 2 is a state diagram to illustrate states and transitions that may be employed in one embodiment of the invention. This example illustrates a processor on which the core speeds may be independently adjusted. In FIG. 2, a startup state 229 is entered when a processor is powered up. The startup state can transition to a boot speed state 223 if startup is successfully completed.

From the boot speed state, the processor can enter a first high speed state 231 if one of the processor cores have a temperature below the high speed threshold 113. If that processor core heats up above the high speed threshold, then the processor core goes back to the boot speed state 223. If after one of the processor cores enters the high speed state, a second processor also has a temperature below the high speed state, then the processor enters a dual core high speed state 233. If either one of the processor cores heats up beyond the high speed threshold, then the processor returns to the single core high speed state 231. If both cores heat up beyond the high speed threshold, then the processor returns to the boot speed state.

As an alternative, there may be multiple independent high speed states, one for each processor core. Each core can then transition between boot speed and high speed states independently based on a temperature measured for the particular processor. There may also be multiple high speed states for each processor core so that any one processor core may operate at several different speeds depending on its temperatures. Each high speed state for any one core may correspond to a different amount of speed increase and a different temperature threshold. Each high speed state, whether for one core or many may have a corresponding voltage level so that higher speeds operate at higher voltages. Other parameters may also be varied with the speed.

As a further alternative, a processor cores may be operated at the same speed and the same voltage. In such a system there is only one high speed state. If all the processor cores are below the high speed threshold 113, then all the processor cores transition to the high speed state 233. If any processor core exceeds the high speed threshold, then all of the processor cores return to the boot speed state 223. Similarly, if any processor core exceeds the throttle threshold 115 or the trip threshold 117, then all the processor cores are throttled 225 or shut down 227.

From the boot speed state 223, the processor may enter a throttled state that is dependent upon the particular processor configuration. If the processor has a single core power plane, then from the boot speed state 223, the processor may also enter throttled speed states 225. If any one core exceeds the throttle threshold 115, then the clock speed for that core or for the processor may be throttled. The voltage and other parameters for that core or for the processor may also be changed in order to reduce its temperature depending upon the design of the processor and the particular application. If the throttled core cools to below the throttled speed threshold, then the processor may return to the boot speed state 223.

If any one of the cores does not cool, but instead continues to heat up to beyond the thermal trip threshold 117, then the processor enters the shutdown state 227. From the shut down state, the processor can start up after it is sufficiently cooled.

The state diagram of FIG. 2 is an example of possible states that can be used for processor operation. More states can be added to support other speed and voltage regimes. The throttle states can be eliminated so that the processor goes directly to the shut down state. Additional states and conditions can be added to the start up and shut down paths and more parameters other than voltage and temperature may be adjusted in any one or more of the states.

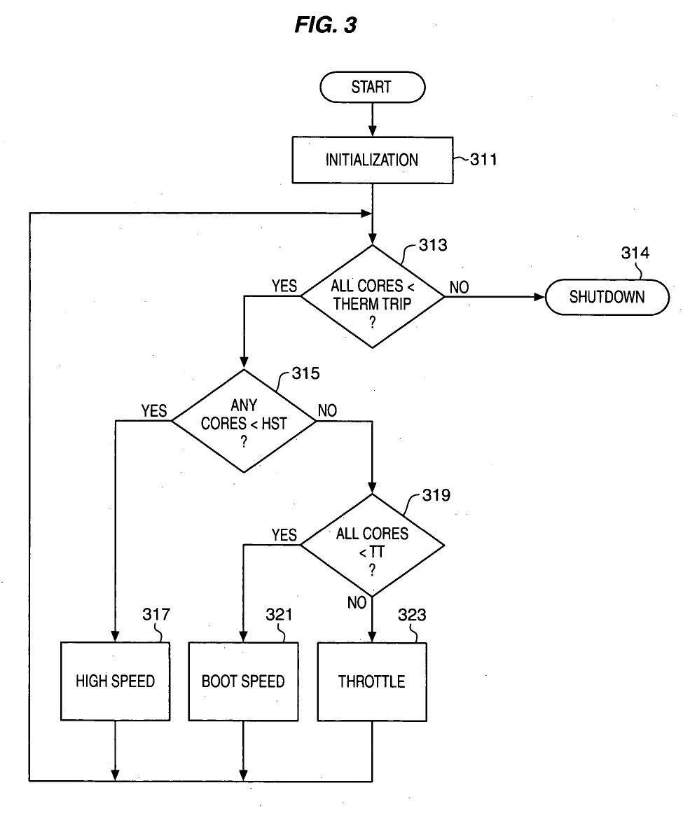

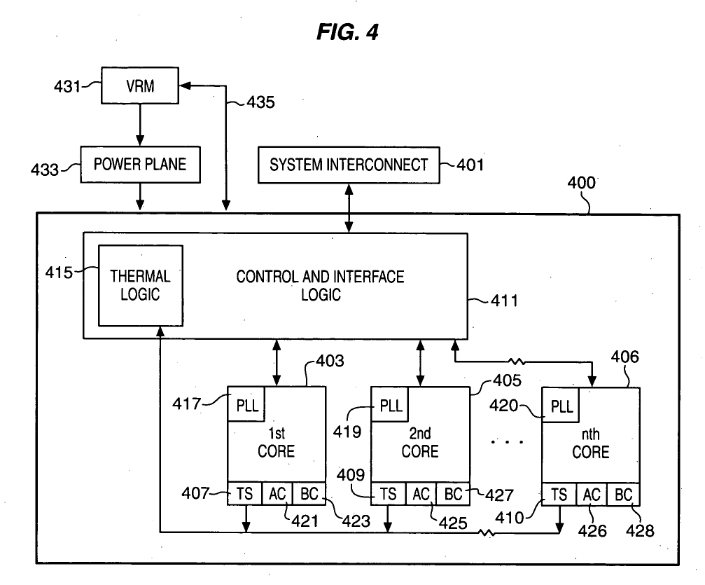

FIG. 3 shows a flow diagram representing a process for implementing the invention according to an embodiment of the invention. This process may be implemented in a special hardware circuit of the processor, such as block 415 of FIG. 4 to maximize speed. It may also be implemented in a system BIOS, in a memory controller hub or other external chip, a thermal management chip or in an operating system. Adjustments in the various thresholds and the speeds of the various states of FIG. 1 may be made to accommodate the responsiveness of any one particular implementation. Alternatively, different portions of the process may be implemented in different places. For example the throttling state may be controlled in a hardware block integrated on the microprocessor die, while the transitions from boot speed to high speed may be implemented in software or an external device.

In FIG. 3, a process begins by initializing the processor at block 311. This may include initializing registers, such as the system bus or system interconnect boot speed fraction, system bus high speed fraction, temperature thresholds and any counters or timers. It may also include initializing processor operation to the boot speed state. The thermal logic or software then performs a test at block 313 to determine whether all of the processing cores are below the thermal trip threshold 117. If any processing cores are above the thermal trip threshold then the processor is shutdown at block 314 to prevent a catastrophic failure.

If all of the processing cores are below the thermal trip threshold, then the processor continues to operate at boot speed and the logic continues to block 315 to determine whether any of the processing cores are below the high speed thermal threshold 113. If all of the cores are at a temperature below the high speed thermal threshold, then the processing cores may be switched to the high speed state at block 317. Alternatively, the test at block 315 may be performed separately for each core so that each core may enter the high speed state independently of the other processing cores. If there is only one processor core, then the test is applied only to that one processing core. From entering the high speed state, the process returns to the thermal trip threshold test at block 313.

If the processing cores are hotter than the high speed threshold 113 at block 315, then the processor core temperatures are compared to the thermal throttle threshold 115 at block 319. If the processor cores are below the throttle threshold, then the processor cores are set to the boot speed state at block 321. Going to the boot speed state may be a transition from the high speed state of block 317 from the throttled state at block 323 or it may be no transition at all if the processor core is already at the boot speed state. As with the high speed state, the test at block 319 and the move to the boot speed state may be performed independently for each processor core or all processor cores may be maintained at the same speed. On the other hand, if any one of the processors is at a temperature above the throttle threshold at block 319, then all of the processor cores enter the throttle state 323 which is a much lower power state intended to cool down the processor.

From all of the three speed states shown in blocks 317, 321 and 323 of FIG. 3, the thermal logic or software returns to recheck the processor core temperatures against all three thresholds at blocks 313, 315, and 319. The process of FIG. 3 may be applied to all of the processor cores as a group so that all of the cores are always operated at the same speed. This simplifies data and instruction transfers between processor cores and external devices. If the processor supports different speeds for different cores, then the test may be applied independently to each processor core so that, for example, it may be possible for one processor core to operate at high speed or boot speed while another processor core is throttled.

Constraints may be added as shown in FIG. 3 so that, for example, if one processor core is over the thermal throttle threshold, then all processor cores are throttled regardless of their measured temperatures. Additional constraints may also be added and additional tests to support other speeds and other temperature thresholds may also be added to the process of FIG. 3. The throttling state may include different types or levels of thermal management using additional tests and blocks and additional higher speed states may be added. The various states of blocks 317, 321, and 323 may include changes in speed, voltage, input/output rates, thermal management and other operating parameters of a processor core.

FIG. 4 shows an example of a dual core processor 400 with temperature sensors to which embodiments of the present invention may be applied. The processor is coupled to a system interconnect 401 to receive a system clock and to communicate data, instructions, status messages and synchronization signals with external devices. The processor is shown with n processing cores. n may be any number from one on up. In FIG. 1, there is a first processing core 403, a second processing core 405, through an nth processing core 406. The processing cores communicate with the system interconnect through Interface and Control Logic (ICL) 411. Each processing core includes a thermal sensor 407, 409, 410 to measure the temperature of the respective core and send a signal that represents the temperature to thermal logic 415 that is located within or in communication with the ICL.

The thermal sensors may be thermal junction diodes or transistors that generate an analog temperature signal or may be digital devices with or without an analog sensor. The thermal sensors may include sampling, averaging, storage or other circuits or logic to pre-process the temperature measurements before they are received by the thermal logic. Alternatively, the thermal logic may receive an analog voltage and perform any desired processing.

The processing cores each also have a PLL (Phase Locked Loop 417, 419, 420) coupled to the ICL to receive system clock pulses and generate the clocks used in the processing core. The PLL's apply a clock ratio to the received clock to determine the operating clock speed for the respective core. If the PLL applies the boot speed ratio, then the corresponding core will operate at boot speed. Similarly if a higher speed ratio is applied, then the core will operate at a higher speed.

The thermal logic reads the temperature measurements from the cores and adjusts the frequency, voltage and other factors as described above with reference to FIGS. 1-3. The thermal logic sends commands, instructions or control signals to the processor's internal clock synchronizing circuitry such as the respective core PLL's 417, 419, 420 and to any external devices, such as power supplies, system memory or external clocks through the ICL.

In one embodiment, the ICL has a control line 435 to a VRM (voltage regulator module) 431 on a system motherboard or other attached infrastructure. The VRM supplies power at a specific voltage to a power plane 433 of the system motherboard. This power plane is coupled to the external power pins of the processor to power the processor. The ICL, through its control line can control the voltage supplied by the VRM. Reducing the voltage for slower speeds reduces the heat generated by the processor.

In the example of FIG. 4, there is a single power plane for the processor so that all of the processor cores operate on the same voltage. In one embodiment, all of the processor cores also operate at the same speed and the voltage is selected as the optimal minimum voltage for that speed. Alternatively, the processors may operate at different speeds and the same voltage or independently controllable voltages may be provided to each processor core. This allows all of the processor cores to operate at different speed and voltage combinations.

Each core also includes count registers. In the illustrated example, each core has an actual count register 421, 425, 426, and a base count register 423, 427, 428. The actual count registers maintain a count that is synchronized to the actual clock speed of the respective core. The base count register is updated at the boot speed. These count registers may be used to measure the operating speed of the respective processing core. A software process, for example an operating system thread allocation process, may read the counter values at two different times and by comparing the counts, determine the boot speed or base speed for the core as well as the actual speed for the core. This information may be used in system diagnostics, and in managing the allocation of tasks, or threads between different processor cores.

The processor may also include many other components which are not shown in order to simplify the diagram of FIG. 4. Such components may include various caches and buffers, diagnostic and system management blocks, timing distribution logic, execution management blocks, speculative execution blocks, interrupt controllers, address generators, instruction decoders, I/O interfaces, etc.

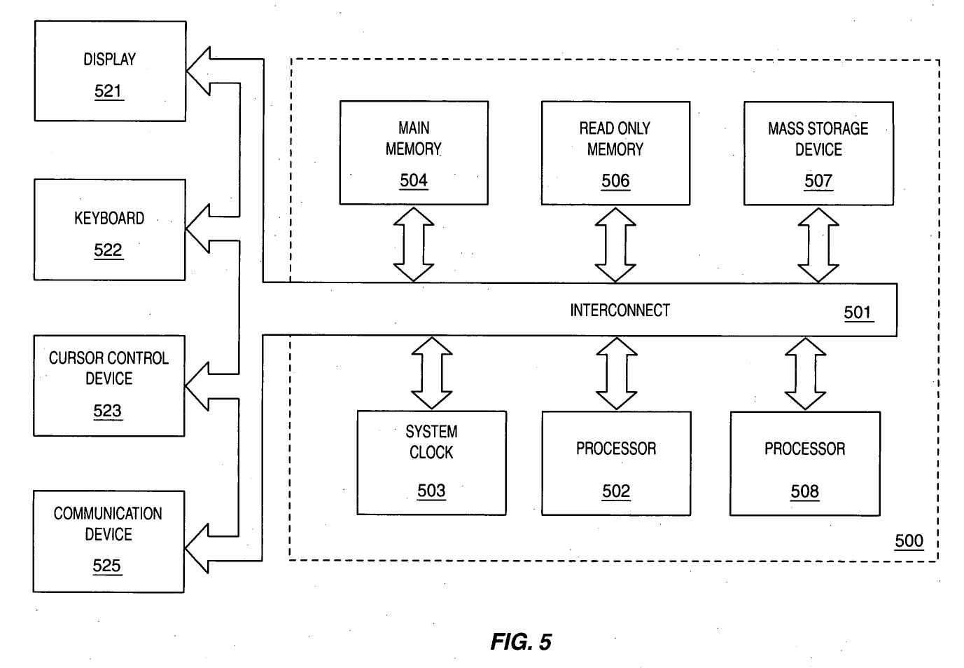

FIG. 5 shows an example of a computer system to which embodiments of the invention may be applied. The computer system 500 includes a system interconnect or other communication means 501 to communicate information, and a processing means such as a single or multiple core processor 502 coupled with the bus to process information. A system clock 503 is coupled to the system interconnect to establish timing for the system interconnect and any synchronized bus devices including the processor. A second processor 508 is also coupled to the system interconnect to provide additional processing capabilities. Additional processors may be used depending on the application. Many servers use four processors and massively parallel systems are in use for scientific applications that use much greater numbers of processors. The processors are all coupled to a power supply plane (not shown) that may provide one or more voltages to the processors and other system components through one or more VRM's (not shown).

A main memory 504, such as a random access memory (RAM) or other dynamic storage device is coupled to the bus for storing information and instructions to be executed by the processor. The main memory may be used to store temporary variables or other intermediate information during execution of instructions by the processor. A read only memory (ROM) or other static storage device 506 is coupled to the system interconnect to store static information and instructions for the processor 502, such as boot up instructions or a system BIOS. A mass data storage device 507 such as a magnetic disk or optical disc and its corresponding drive may also be coupled to the computer system to store information and instructions, such as applications and user files.

The computer system may also be coupled via the system interconnect or a peripheral bus to a variety of I/O (input/output) and peripheral devices. A display device 521, such as a cathode ray tube (CRT) or Liquid Crystal Display (LCD), to display information to an end user is coupled to the system interconnect. An alphanumeric input device 522, such as a keyboard or number pad, may be coupled to the bus 501 to communicate information and command selections to the processor 502. A cursor control device 523, such as a mouse, a trackball, or cursor direction keys is also coupled to the bus to communicate direction information and command selections to the processor and to control cursor movement on the display.

A communication device 525 is coupled to the bus 501. The communication device 525 may include a modem, a network interface card, or other well known interface devices, such as those used for coupling to Ethernet, token ring, or other types of physical or wireless attachment to provide a communication link to support a local or wide area network, for example.

It is to be appreciated that a lesser or more equipped computer system than the example described above may be desirable for certain implementations. Additional buses or different buses may be used and additional devices may be added to the computer system. Some of the illustrated devices may also be removed from the computer system. The configuration of the computer system may vary with different implementations depending upon numerous factors, such as price constraints, performance requirements, technological improvements, or other circumstances.

Although the description of the various embodiments refers primarily to using a dual core processor in conjunction with a system bus or system interconnect, the various embodiments may also be used with processors that have a single core or that have more than two processing cores. The processing cores may be capable of processing only a single thread or multiple threads. Embodiments of the invention may also be used with other types of integrated circuits, such as microcontrollers, FPGA's (Field Programmable Gate Arrays), ASIC's (Application Specific Integrated Circuits), DSP's (Digital Signal Processors), motherboard chipsets or memory chips.

Embodiments of the present invention may be provided as a computer program product which may include a machine-readable medium having stored thereon instructions which may be used to program a control station, a microcontroller or other electronic device to perform a process. The machine-readable medium may include, but is not limited to, floppy diskettes, optical disks, CD-ROMs, and magneto-optical disks, ROM's, RAM's, EPROM's, EEPROM's, magnet or optical cards, flash memory, or other type of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

It is to be appreciated that a lesser or more complex processor, thermal threshold regime, state engine, thermal sensor, and thermal management system than the examples described above may be preferred for certain implementations. Therefore, the configurations and the processes may vary from implementation to implementation depending upon numerous factors, such as the type of integrated circuit, the likely operating environment, the desired performance, or other circumstances. Embodiments of the invention may also be applied to other types of systems that use different devices than those shown in the Figures.

In the description above, numerous specific details are set forth. However, it is understood that embodiments of the invention may be practiced without these specific details. For example, well-known equivalent materials may be substituted in place of those described herein, and similarly, well-known equivalent techniques may be substituted in place of the particular processes disclosed. In other instances, well-known structures and techniques have not been shown in detail to avoid obscuring the understanding of this description.

While the embodiments of the invention have been described in terms of several embodiments, those skilled in the art will recognize that the invention is not limited to the embodiments described, but may be practiced with modification and alteration within the spirit and scope of the appended claims. The description is thus to be regarded as illustrative instead of limiting.

1. A method comprising:
comparing a first processing core temperature to a first threshold and to a second threshold;
comparing a second processor core temperature to the first threshold and to the second threshold the first processor core and the second processor core being in the same processor;
increasing the speed of the first processor core from a first speed to a second higher speed if the first core temperature is below the first threshold;
increasing the speed of the second processor core from a first speed to a second higher speed if the second core temperature is below the first threshold; and
decreasing the speed of the first and the second processor cores from the first speed to a third lower speed if either the first core temperature or the second core temperature is above the second threshold.

2. The method of claim 1, wherein increasing the speed comprises increasing the voltage of the respective processor core if the respective core temperature is below the first threshold.

3. The method of claim 1, further comprising decreasing the voltage of the first and the second processor cores if either the first or the second processor core temperature is above the second threshold.

4. The method of claim 1, further comprising after increasing the speed of the respective processor core, comparing the respective core temperature at the second speed to the first threshold, and if the respective second speed core temperature is above the first threshold, then reducing the respective processor core speed from the second speed to the first speed.

5. (canceled)

6. (canceled)

7. A machine-readable medium comprising data that when operated on by the machine cause the machine to perform operations comprising:
detecting an operating temperature of a first processor core and a second processor core;
comparing the detected temperatures to a first threshold;
increasing the speed of the first and the second processor core from a first speed to a second higher speed if the detected temperature of at least one of the first and second processor core is below the threshold; and
decreasing the speed of the first and the second processor cores from the second speed to a third slower speed if the detected temperature of either one or both of the first and the second processor cores is above a second higher threshold.

8. The medium of claim 7, the operations, further comprising comparing the detected temperatures to a second threshold and decreasing the speed of the first and the second processor cores, respectively, from the first speed to a third lower speed if the detected temperature of the first and the second processor core, respectively, is above the second threshold.

9. The medium of claim 7, the operations further comprising increasing the voltage of the first and the second processor cores if the detected temperature are below the first threshold.

10. The medium of claim 7, the operations further comprising after increasing the speed of the first and the second processor cores, detecting an operating temperature of the first and second processor cores at the second speed, comparing the detected temperatures to the first threshold and if the detected temperatures are above the first threshold, then reducing the speed of the first and the second processor cores from the second speed to the first speed.

11-14. (canceled)

15. An apparatus comprising:
a first processor core;
a second processor core;
a first thermal sensor to sense the temperature of the first processor core;
a second thermal sensor to sense the temperature of the second processor core; and
thermal logic coupled to the thermal sensors and to the processor cores to compare the temperatures from the thermal sensors to a threshold, to increase the speed of the respective processor core from a rated speed to a second higher speed if the respective sensed temperature is below the threshold, to decrease the speed of the respective processor core from the second higher speed to the rated speed if the respective sensed temperature is above the threshold and to decrease the speed of both of the processor cores to a third slower speed if the sensed temperature of either processor core is above a second higher threshold.

16. (canceled)

17. (canceled)

18. A computer system comprising:
a system clock;
a system bus coupled to the system clock; and
a processor coupled to the system bus, the processor having a first and a second processor core. a first and a second thermal sensor to sense the temperature of the first and the second processor cores, and thermal logic coupled to the thermal sensors and to the processor cores to compare the temperature from the thermal sensors to a first threshold, to increase the speed of the respective processor core relative to the system clock from a marked speed to a second higher speed if the corresponding sensed temperature is below the first threshold, and to decrease the speed of both processor cores relative to the system clock to a third slower speed if the sensed temperature is above a second higher threshold.

19. The apparatus of claim 18, wherein the thermal logic further increases the voltage of the respective processor core if the respective detected temperature is below the first threshold.

20. The apparatus of claim 18, wherein the thermal logic further decreases the voltage of the respective processor core if the respective detected temperature is above a third threshold between the first threshold and the second threshold.

21. The apparatus of claim 18, wherein the thermal logic decreases the speed of the respective processor core relative to the system clock from the second higher speed to the rated speed if the sensed temperature of the respective processor core is above a third threshold between the first threshold and the second threshold
